(19) United States
(12) Patent Application Publication
(10) Pub. No.: US 2015/0266279 A1
(43) Pub. Date: Sep. 24, 2015

(54) PROTECTIVE FILM

(71) Applicant: CORNING PRECISION MATERIALS CO., LTD., Chungcheongnam-do (KR)

(72) Inventors: Hae-Deuk Jeong, Chungcheongnam-do (KR); Eun-Jeong Shin, Chungcheongnam-do (KR); Sangku Moon, Chungcheongnam-do (KR)

(73) Assignee: CORNING PRECISION MATERIALS CO., LTD., Chungcheongnam-do (KR)

(21) Appl. No.: 14/661,673

(22) Filed: Mar. 18, 2015

(30) Foreign Application Priority Data
Mar. 21, 2014 (KR) 10-2014-0033308

(51) Int. Cl. B32B 27/08; C09J 7/00; B32B 27/18

(52) U.S. Cl. CPC B32B 27/08; B32B 27/18; C09J 7/00; B32B 2405/00; B32B 2571/00; B32B 2457/20; C09J 201/00

(57) ABSTRACT

A protective film includes an adhesive layer containing a first synthetic resin, and a non-adhesive layer containing a second synthetic resin and micro-beads made of a polymer, the micro-beads being distributed in the second synthetic resin. The adhesive layer and the non-adhesive layer are laminated on each other.

### BACKGROUND OF THE INVENTION

1. Field of the Invention

The present invention relates to a protective film, and more particular, to a protective film in which a non-adhesive layer having micro-beads distributed therein and an adhesive layer are laminated on each other.

2. Description of Related Art

Since glass plates used for displays are subjected to a thin-film process involving a thin-film transistor in a clean room, a high level of cleanliness is required for such glass. Therefore, a protection method is used in order to protect glass plates during loading and carrying from a manufacturer to a consumer (a display device manufacturer). A method that is typically used includes loading and carrying glass plates by sticking protective films to both sides of each glass plate.

FIG. 1 is a view schematically showing a glass loading method of the related art.

As shown in FIG. 1, the glass loading method using protective films of the related art includes sticking protective films 2 to both sides of a glass plate 1 such that they are weakly adhered to the glass plate 1, erecting or overlapping a plurality of glass plates 1 to which protective films 2 are stuck, and situating paper sheets 3 between the protective films 2, and loading the resultant stack. The paper sheets 3 serve to prevent protective films 2 from sticking to each other, thereby preventing the protective films 2 from being separated from a designated glass plate or being attached to the wrong glass plate which is carried. However, this glass loading method has the following problems: Resources are spent due to the use of paper sheets, the working environment becomes more complicated, and glass treatment in the process becomes complicated.

FIG. 2 is a view schematically showing another glass loading method of the related art.

A functional protective film 4 was developed in order to overcome the problems in FIG. 1. In the functional protective film 4, two or more layers including a self-adhesive layer and a non-adhesive layer are combined such that glass plates can be easily separated one by one during the process of loading and carrying glass. Consequently, the glass loading method which does not need paper sheets can be used.

The non-adhesive layer of the functional protective film 4 is surface-controlled so as to decrease contact area and to form a large amount of air gaps between a glass plate and the protective film, thereby lowering the separation resistance. This consequently prevents the film or glass from adhering or being fractured which would otherwise occur during the glass loading/carrying process.

As a machining method intended to control surface roughness, a method of using micro-beads 145b and 245b is typically used (see FIG. 5 and FIG. 6). This method has the advantage of superior machinability. However, since the micro-beads 145b and 245b used in the method are manufactured by cold grinding (top-down processing), the shapes are irregular and the sizes are non-uniform. It is disadvantageous to control the surface roughness of protective films 140 and 240. In addition, since the mechanical force that occurs during loading of the glass is concentrated on the irregular micro-beads 145b and 245b, the components of the micro-beads 145b and 245b are transferred to the glass surface, thereby forming stains. (Part (a) of FIG. 3 shows a glass plate on which a stains is formed on the surface, and part (b) of FIG. 3 shows a normal glass plate). In addition, the processing environment and the surface quality of films are deteriorated by fine dust during manufacturing of the films (see FIG. 4). There is also a danger in that the micro-beads 145b and 245b may be transferred to another protective film, as well as a danger of upset of the micro-beads 145b and 245b. In addition, there is a problem in that the dust of the micro-beads 145b and 245b reside on the glass surface, thereby significantly deteriorating the quality of the glass surface. In the figures, reference numerals 141 and 241 designate an adhesive layer, 143 and 243 designate an intermediate layer, 145 and 245 designate a non-adhesive layer, and 145a and 245a designate synthetic resins.

The information disclosed in the Background of the Invention section is provided only for better understanding of the background of the invention, and should not be taken as an acknowledgment or any form of suggestion that this information forms a prior art that would already be known to a person skilled in the art.

### BRIEF SUMMARY OF THE INVENTION

Various aspects of the present invention are to provide a high-quality protective film which protects glass by overcoming the problems occurring with the protective film of the related art and diversifying the function of micro-beads.

In an aspect of the present invention, provided is a method of manufacturing a protective film in which an adhesive layer and a non-adhesive layer are laminated on each other. The method includes the process of making the non-adhesive layer by: a) preparing micro-beads through polymerization; b) mixing the micro-beads into a synthetic resin; and c) converting a mixture including the micro-beads and the synthetic resin into a lamellar structure.

In another aspect of the present invention, provided is a protective film that includes: an adhesive layer containing a first synthetic resin; and a non-adhesive layer containing a second synthetic resin and micro-beads made of a polymer, the micro-beads being distributed in the second synthetic resin. The adhesive layer and the non-adhesive layer are laminated on each other.

According to embodiments of the present invention, there are the following advantages. Since micro-beads are made by polymerization (bottom-up processing), size distribution control over the micro-beads is easy. In addition, since the micro-beads are spherical, the roughness of the film surface can be easily controlled.

Since the micro-beads made through polymerization are spherical, it is possible to obtain the buffering effect to external mechanical forces and improved resistance to scratches.

Since the micro-beads are inserted into the non-adhesive layer, it is possible to minimize organic matters that are transferred to the glass surface, thereby reducing stains and scratches which would otherwise deteriorate the surface quality of the glass.

Since the micro-beads made through polymerization have regular shapes and superior size uniformity, the dispersibility of the micro-beads inside the synthetic resin is further improved. It is therefore possible to make the micro-beads at a content (20 wt % or less) lower than the content proposed in the related art (the content ranging from 30 to 60 wt %).

Use of the micro-beads made through polymerization can reduce the problems which are caused by dust, such as process contamination and surface quality deterioration in the protective film and the glass.

In addition, it is possible to form pores inside the functional protective film by controlling the surface characteristics of the micro-beads such that the affinity of the non-adhesive layer to the synthetic resin is reduced and then performing crystallization and elongation. The pores formed inside the functional protective film can enhance the buffering effect to the mechanical force that occurs during loading of glass, thereby effectively reducing stains and scratches.

The present invention employs the micro-beads made through polymerization (bottom-up processing) and diversifies the functionality of the micro-beads, thereby maintaining the advantages while reducing the drawbacks of the functional protective film of the related art. This consequently allows glass plates for displays to maintain superior surface quality.

The methods and apparatuses of the present invention have other features and advantages which will be apparent from, or are set forth in greater detail in the accompanying drawings, which are incorporated herein, and in the following Detailed Description of the Invention, which together serve to explain certain principles of the present invention.

### BRIEF DESCRIPTION OF THE DRAWINGS

FIG. 1 is a view schematically showing a glass loading method of the related art;

FIG. 2 is a view schematically showing another glass loading method of the related art;

FIG. 3 is a view showing stains that may occur on glass in the glass loading method shown in FIG. 2;

FIG. 4 is a view showing contamination that is caused by fine dust in the process of manufacturing films;

FIG. 5 is a view showing an example of a functional protective film of the related art which is used in the loading method shown in FIG. 2;

FIG. 6 is a view showing another example of the functional protective film of the related art which is used in the loading method shown in FIG. 2;

FIG. 7 is a view showing a functional protective film according to an embodiment of the present invention;

FIG. 8 is a view showing a functional protective film according to another embodiment of the present invention; and

FIG. 9 to FIG. 11 views showing a variety of methods of laminating adhesive and non-adhesive layers according to the present invention.

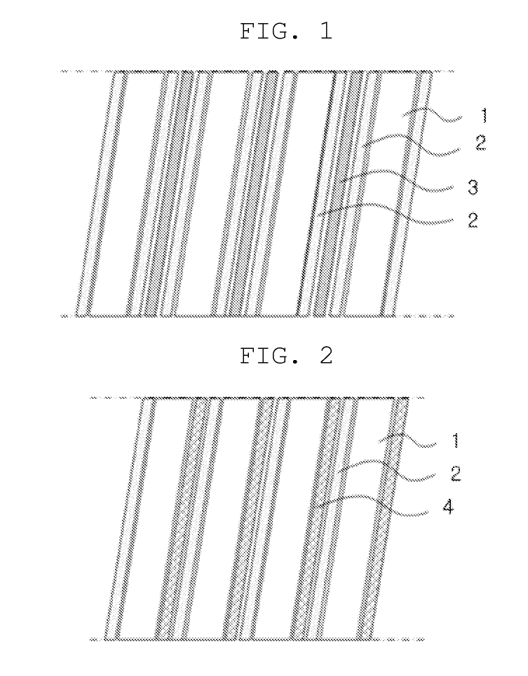

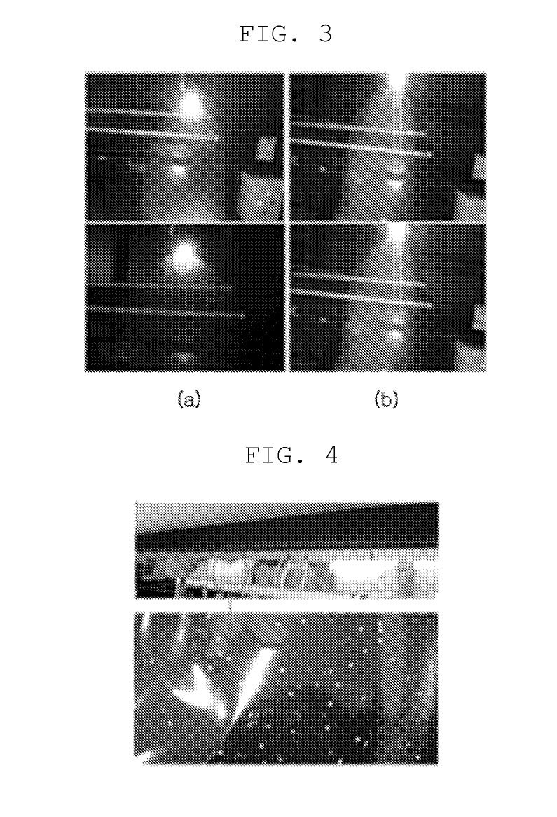

### DETAILED DESCRIPTION OF THE INVENTION

Reference will now be made in detail to various embodiments of the present invention, examples of which are illustrated in the accompanying drawings and described below, so that a person having ordinary skill in the art to which the present invention relates can easily put the present invention into practice.

FIG. 7 is a view showing a functional protective film 340 according to an embodiment of the present invention.

The protective film 340 according to this embodiment includes at least two layers, i.e. an adhesive layer 341 and a non-adhesive layer 345, which are laminated on each other. The protective film 340 shown in FIG. 7 also includes an intermediate layer 343 which is situated between the adhesive layer 341 and the non-adhesive layer 345.

The protective film is typically used to protect a glass plate by being stuck to the glass plate. However, the present invention is not limited to this use. The adhesive layer of the protective film is stuck to the glass plate, and the non-adhesive layer is disposed opposite the adhesive layer.

The adhesive layer is typically stuck to the glass plate through self-adhesion, without an adhesive or bonding agent being interposed. However, the present invention is not limited thereto. The adhesive layer 341 contains a first synthetic resin. When the adhesive layer is a self-adhering adhesive layer, the first synthetic resin may be a polyolefin-based polymer, such as polyolefin, or a polymer produced through co-polymerization of an olefin-based monomer, such as ethylene vinyl acetate (EVA), ethylene acrylic acid (EAA) or ethylene methyl methacrylate (EMMA), and a monomer having a polar group. The first synthetic resin may also be one selected from among, but not limited to, a polyolefin-based rubber and other types of rubber.

Since the adhesive force of the self-adhering adhesive layer is limited or weak, when a strong adhesive force is required or the surface of a product to be protected is rough, it is possible to use an adhesive layer by applying an adhesive, such as an acrylic adhesive, to the surface thereof instead of the self-adhering adhesive layer. However, when an adhesive or bonding agent is used, the adhesive or bonding agent resides on the glass after the protective film is removed. Therefore, it is preferable to use a self-adhering adhesive layer.

The intermediate layer is typically made of polyethylene, and more preferably, low-density polyethylene.

The non-adhesive layer contains a second synthetic resin 345a and micro-beads 345b. The micro-beads 345b are distributed in the second synthetic resin. It is preferred that the melting point of the micro-beads be higher than the melting point of the second synthetic resin.

The non-adhesive layer of the protective film shown in FIG. 7 can be manufactured by the following process including the steps of:

a) preparing micro-beads through polymerization;

b) mixing the micro-beads into synthetic resin; and

c) converting the mixture including the micro-beads and the synthetic resin into a lamellar structure.

In the a) step, polymeric micro-beads are prepared by mixing a monomer, a cross-linking agent and other additives into a polymeric stabilizer, followed by suspension polymerization. The resultant micro-beads are preferably cleaned and dried.

In the b) step, the micro-beads are uniformly mixed into the second synthetic resin using a single or twin screw extruder. After the micro-beads are mixed into the second synthetic resin and the mixture is extrusion-molded, a masterbatch can be made, and in the subsequent c) step, a non-adhesive layer having the lamellar structure can be molded by extruding the masterbatch.

The second synthetic resin may be implemented as a synthetic resin, the melting point of which is lower than the melting point of the micro-beads. For instance, the second synthetic resin may be implemented as one selected from among, but not limited to, i) polyethylene, ii) polypropylene and iii) polyolefin-based polymeric copolymers, and iv) polystyrene, v) polycarbonate, vi) polymethyl methacrylate and vii) acrylonitrile butadiene styrene-based copolymers.

The micro-beads can be implemented as micro-beads, the melting point of which is higher than the melting point of the second synthetic resin. It is preferred that the micro-beads be spherical. For instance, the micro-beads can be made of one selected from among, but not limited to, i) polyethylene, ii) polypropylene, iii) polymethyl methacrylate, iv) polystyrene, v) polyurethane and vi) cellulose acetate.

In the embodiment shown in FIG. 7, it is preferred that the micro-beads are hydrophobic. For example, hydrophobic micro-beads can be used or a hydrophobic functional group can be formed on the surface of micro-beads by surface-treating the micro-beads.

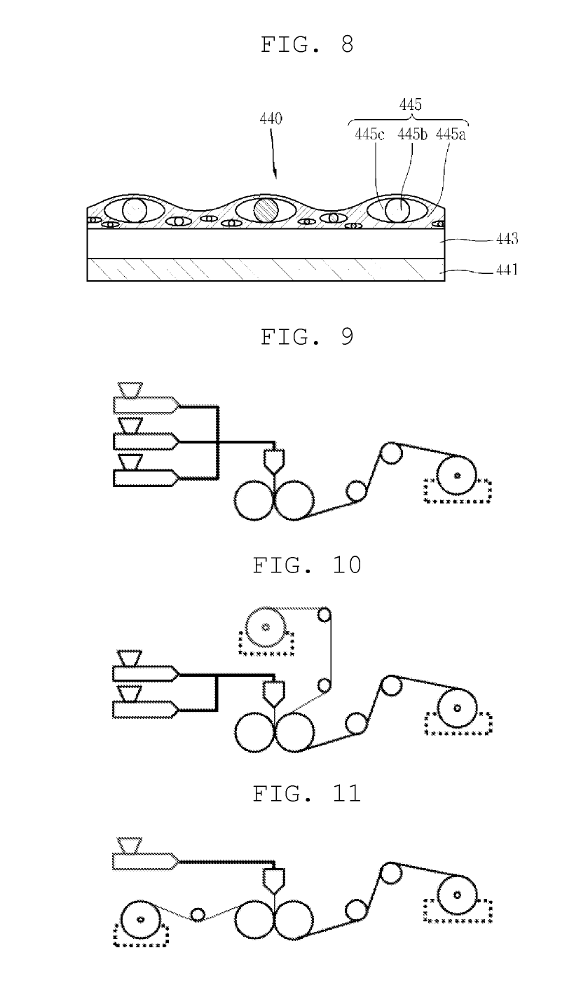

The multilayer structure including the adhesive layer and the non-adhesive layer can be produced in a variety of methods shown in FIG. 9 to FIG. 11.

First, as shown in FIG. 9, it is possible to form a polymer melt in which two or more layers are combined through co-extrusion of a raw material for the adhesive layer, i.e. the first synthetic resin, and a raw material for the non-adhesive layer made in the b) step (the mixture including the second synthetic resin and the micro-beads), cooling the resultant polymer melt, and then winding the cooled polymer melt.

Alternatively, as shown in FIG. 10, it is possible to manufacture a protective film by making a non-adhesive film in advance through the foregoing a) to c) steps separate from the adhesive layer and then extruding the first synthetic resin on the non-adhesive film.

In addition, as shown in FIG. 11, it is possible to manufacture a protective film by making an adhesive film from the first synthetic resin and then extruding the raw material for the non-adhesive layer (the mixture including the second synthetic resin and the micro-beads) on the adhesive film.

Although the extrusion was illustrated as an example of the lamellar processing, the present invention is not necessarily limited thereto.

FIG. 8 is a view showing a functional protective film according to another embodiment of the present invention.

A non-adhesive layer 445 of the protective film shown in FIG. 8 can be manufactured in a method similar to that of FIG. 7.

In contrast, in the a) step, micro-beads 445b are surface-treated, thereby generating a hydrophilic functional group ((—OH, —COOH, —NH₂) on the surface of the micro-beads 445b. Hydrophilic surface treatment can be precluded when hydrophilic micro-beads are used. The surface hydrophilicity of the micro-beads decreases affinity to a second synthetic resin 445a, thereby helping pores 445c form between the micro-beads and the second synthetic resin.

In addition, in the c) step, the non-adhesive layer that is molded into the lamellar structure is crystallized and then elongated, thereby forming pores around the micro-beads. Crystallization is influenced by the cooling speed. When the non-adhesive layer is crystallized more, elongation becomes difficult. However, this helps pores form since the affinity of the non-adhesive layer to the micro-beads is reduced. In contrast, when the non-adhesive layer is less crystallized, elongation becomes easy. However, it is difficult to form pores since the affinity of the non-adhesive layer to the micro-beads is increased. Therefore, it is important to realize elongation and affinity to micro-beads at required levels by controlling the degree of crystallization through adjustment of the cooling speed.

Reference numerals 441 and 443 respectively designate an adhesive layer and an intermediate layer.

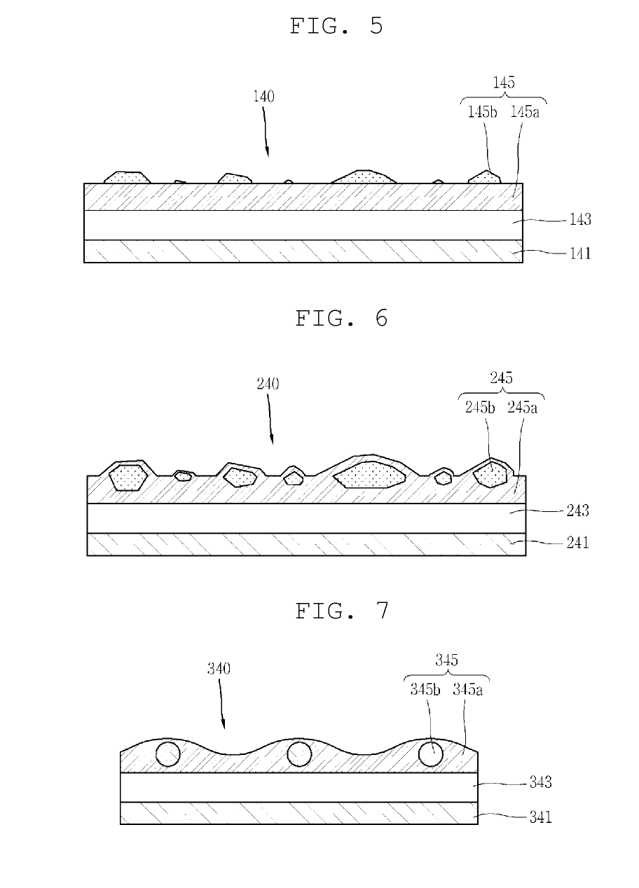

The micro-beads on the non-adhesive layer shown in FIG. 5 and FIG. 6 are ground in the order of size through cold grinding (top-down processing). Therefore, the micro-beads shown in FIG. 5 and FIG. 6 have the problem of shape and size distribution control. In contrast, the micro-beads shown in FIG. 7 and FIG. 8 are polymerized in the reverse order of size so that smaller beads are synthesized before larger beads (bottom-up processing). Therefore, shape and size distribution control is easy for the micro-beads shown in FIGS. 7 and 8. (In particular, the micro-beads shown in FIGS. 7 and 8 can be included by only 20 wt % or less, whereas the content of the micro-beads shown in FIG. 6 ranges from 30 to 60 wt %.) In addition, the roughness of the film surface can be easily controlled. Furthermore, the micro-beads shown in FIG. 7 and FIG. 8 can be spherical. It is therefore possible to obtain the buffering effect to mechanical stress and prevent scratches. In particular, the non-adhesive layer shown in FIG. 8 is effective in buffering mechanical stress since it has pores therein.

The process of applying micro-beads on the non-adhesive layer shown in FIG. 5 is separate post-process. This consequently requires introduction of additional equipment such as a micro-bead injector and causes the problem of process environmental contamination due to fine dust of micro-bead. However, in case of FIG. 7 and FIG. 8, post-process is unnecessary step. Therefore, it is not required to introduce additional equipment, and there is no risk of process environmental contamination due to dust. In addition, since the micro-beads shown in FIG. 5 are exposed to the outside of synthetic resin, dust may be transferred to glass, thereby deteriorating the surface quality of the glass, which is problematic. In contrast, the micro-beads shown in FIG. 7 and FIG. 8 are present inside the second synthetic resin without causing dust transfer.

The foregoing descriptions of specific exemplary embodiments of the present invention have been presented with respect to the drawings. They are not intended to be exhaustive or to limit the present invention to the precise forms disclosed, and obviously many modifications and variations are possible for a person having ordinary skill in the art in light of the above teachings.

It is intended therefore that the scope of the present invention not be limited to the foregoing embodiments, but be defined by the Claims appended hereto and their equivalents.

What is claimed is:

1. A protective film comprising:
an adhesive layer containing a first synthetic resin; and
a non-adhesive layer containing a second synthetic resin and micro-beads made of a polymer, the micro-beads being distributed in the second synthetic resin,
wherein the adhesive layer and the non-adhesive layer are laminated on each other.

2. The protective film of claim 1, wherein the polymer comprises a suspension polymer.

3. The protective film of claim 1, wherein a melting point of the micro-beads is higher than a melting point of the second synthetic resin.

4. The protective film of claim 1, wherein at least surfaces of the micro-beads are hydrophilic or hydrophobic.

5. The protective film of claim 1, wherein the non-adhesive layer has pores around the micro-beads.

6. The protective film of claim 1, being a glass protective film used for protecting a glass plate, with the adhesive layer being stuck to the glass plate.
